(19) United States
(12) Patent Application Publication
(10) Pub. No.: US 2009/0053547 A1
(43) Pub. Date: Feb. 26, 2009

(54) Component Made From Aluminium Material With a Partial or Complete Coating of the Surfaces for Brazing and Method for Production of the Coating

(76) Inventors: Norbert William Sucke, Duisburg (DE); Michael Dvorak, Thun (DE)

Correspondence Address: FRIEDRICH KUEFFNER, 317 MADISON AVENUE, SUITE 910, NEW YORK, NY, 10017, US

(21) Appl. No.: 11/886,823

(22) PCT Filed: Mar. 22, 2006
(86) PCT No.: PCT/EP2006/002627

§ 371 Date: Sep. 21, 2007

(30) Foreign Application Priority Data
Mar. 22, 2005 (DE) 102005013729.6
Mar. 22, 2005 (DE) 202005004807.0

(51) Int. Cl. B32B 15/02; B23K 1/20

(52) U.S. Cl. 428/548; 228/208

(57) ABSTRACT

The invention relates to a component made from aluminium material with a partial or complete coating of the surfaces for brazing and method for production of the coating. According to the method, fine-grain particulate brazing material is at least partly fused by means of a low temperature plasma beam and spayed onto the surfaces of the component in fused form, whereby the brazing agent forms a uniform good adhesion to the surfaces of the component. The application of the brazing agent can occur at any region of the surfaces of the component, for example, even on the edges. The particular advantage of said method is that a precisely dosed, uniform and well adhering coating of brazing agent can be achieved, whereby the use of solvents and binders can be avoided in the production process which is environmentally-friendly.

The invention concerns a component made of aluminum material, i.e., a component made of aluminum or an aluminum alloy, with partial or complete coating of the surfaces for brazing. These components are typically hollow multichamber extruded sections for heat exchangers, for example, evaporators or condensers (liquefiers). Hollow multichamber extruded sections of this type are extruded as flat sections, provided with brazing materials, and joined by brazing with the other components of the heat exchanger, such as plates and/or collecting tubes. The plates and collecting tubes can also be provided with a coating of brazing material, but it is preferred that the flat hollow multichamber extruded sections be coated.

Many different methods for accomplishing this are known. The document U.S. Pat. No. 6,136,380 describes an immersion method, in which a flat extruded section is passed through a dip bath. This liquid bath (slurry) contains a powdered brazing alloy, a powdered brazing flux, and a binder, which are mixed in a solvent. This method makes it possible not only to produce coated hollow multichamber extruded sections in an in-line process together with the operation of cutting the hollow sections to length, but also to carry out a coating operation separately from the operation of cutting the sections to length. In this method, the entire surface of the flat section is furnished with a coating of brazing material. The layer thickness of the coating can be adjusted by means of stripping rollers installed downstream of the immersion bath.

In another method disclosed in DE 199 07 294 and WO 2001/038040, the coating is carried out with coating rollers, which transfer the brazing material to the surface of the section. In this regard, generally only the wide sides of the section are coated, i.e., especially in the edge region, no coating or only an inadequate coating is guaranteed. In this coating method with the use of coating rolls, the brazing material, which consists of brazing alloy, brazing flux, and binder, is also applied dissolved in a solvent. This has the serious disadvantage that the evaporation of the solvent results in extensive emissions that can harm the environment and human health. Moreover, to ensure adequate adhesion of the flux and the brazing alloy, it is necessary to use a relatively large amount of binder, which burns during the brazing process and leads to undesirable residues in the brazing furnace.

DE 198 59 735 discloses a powder coating method for brazing materials, in which the brazing alloy, the flux, and the binder are applied in powdered form to the heat exchanger sections. A process of this type also allows coating at high coating speeds and integration in existing process sequences. Another advantage of this method is that only a limited amount of binder is required. However, binder can be completely eliminated only if the brazing alloy and/or the flux is applied immediately before the brazing process. This is realized by electrostatic powder coating immediately before the brazing process. In this regard, flux is also applied to the plates, although this is not required by the process. In regard to the economy of the process, incorporation of the coating process in the process of manufacturing the extruded section has been found to be more economical. In this case, it is possible especially to utilize the extrusion process heat to achieve better adhesion of the coating on the flat section. This method also fails to achieve uniformly good adhesion in the edge regions of the extruded sections.

The objective of the invention is to make available components made of aluminum material with a uniform and strongly adhering coating of brazing material on all desired surface regions of the component, including especially the edge regions, such that these components can be economically manufactured and result in the smallest possible environmental pollution by solvent emissions and emissions of pyrolysis products of the binder.

This objective is achieved with a component made of aluminum material with partial or complete coating of the surfaces with brazing material in accordance with the features of claim 1. A method for producing a component of this type is disclosed in claim 5.

The brazing material is a fine-grained powder. It can contain or consist of a silicon powder or a brazing alloy powder, such as an aluminum-silicon alloy powder, preferably a hypoeutectic Al—Si(7-12.5) alloy powder or a hypereutectic Al—Si(12.6-40) alloy powder. A flux powder with or without binder can be used additionally or separately. All customary fluxes can be used, for example, noncorrosive metal fluoride powders, especially alkali metal fluoroaluminate powders, e.g., K₁₋₃AlF₄₋₆. However, it is also possible to use reactive fluxes, such as alkali metal fluorosilicate (K₂SiF₆) or alkali metal fluorozincate (K₂ZnF₃). The alkali metal used in these types of fluxes is usually potassium, but cesium or rubidium are also possible. Due to the good adhesion of the fused powder particles of the brazing alloy powder and/or flux powder, the use of a binder can be dispensed with entirely.

The fine-grained brazing powder contains powder particles with sizes of 50 nm to 100 μm, which are applied to the surfaces by metering in layer thicknesses up to 100 μm. In the case of narrow powder particle size spectra, for example, powder particle sizes in the range of 3-25 μm, very uniform coatings are obtained, and good metering of the individual components of the brazing material is achieved. The total amount of brazing material applied is up to 25 g/m². When the amount applied is up to 10 g/m², the layer of brazing material is usually a monoparticle layer, i.e., the molecules of flux and brazing alloy adhere to the aluminum of the component. When the amount applied is greater, the addition of small amounts of binder is possible (less than 20 wt. %) to improve adhesion of the additional particles of flux and brazing alloy. In this connection, all known binders with a particle size less that 20 μm can be used, namely, standard binders in the form of clear lacquer, as well as binders for reactive fluxes, for example, the Rohm and Haas products Acryloid B67 or Paraloid B72.

In one variant of the method, good adhesion of the brazing material to the surface of the component is achieved by virtue of the fact that the fine-grained particles of brazing powder are applied to the surface and adhere to it in fused form. The good adhesion is produced, on the one hand, by mechanical clinging of the particles of brazing material to the aluminum surface. In addition, depending on the choice of powders and the power of the plasma stream, the heat energy of the applied particles of some powdered brazing materials is conducive to diffusion of these particles into the surface of the aluminum. To achieve adequate adhesion, it is necessary for the degree of fusion of the fine-grained brazing powder to be at least 10%. If the degree of fusion is higher, good adhesion to the surface of the component will be realized in any case. Process engineering allows degrees of fusion of 10% to 100% to be achieved, but an upper limit of 80% is selected in order to prevent overheating of the brazing material and fusion of the aluminum.

In an alternative variant of the method, good adhesion to the surface is achieved by applying the fine-grained particles of brazing powder to the surface of the aluminum component from the vapor phase. In this process, the particles of brazing powder are converted to the vapor phase in the low-temperature plasma.

A degree of fusion of the fine-grained brazing powder of at least 10% is achieved by supplying energy. In one possible process, the surface of the component can be bombarded with highly accelerated powder particles, whose high kinetic energy causes them to fuse with and adhere to the surface as they strike it. However, since this method produces a large amount of overspray, it is preferable for the brazing material to be applied by a low-temperature plasma beam. Temperatures of 6,000 K to 20,000 K are usually measured in a plasma beam. Temperatures of 500 K to 2,000 K can be adjusted in a low-temperature plasma. Temperatures of 500° C. to 1,000° C. are preferred for coating aluminum components with brazing material. The fine-grained brazing powder is partially fused at these temperatures. The degree of fusion of the brazing material can be adjusted by controlling the electric power used to generate the low-temperature plasma beam, the volume flow of the plasma gas, and the composition of the plasma gas. The brazing material is sprayed onto the surface of the component in partially fused form. To this end, the plasma flame is brought into contact with the surface of the aluminum component that is to be coated. This direct contact of the low-temperature plasma beam with the surface of the component prevents undesirable reactions of the brazing material with the ambient atmosphere.

In one embodiment of the method of the invention, the temperature of the low-temperature plasma beam can be adjusted in such a way that, when brazing alloy powder and flux powder are used, primarily the flux powder fuses. A temperature range of the low-temperature plasma beam of, for example, 530-620° C. is used for this purpose and especially a range of 550-600° C. If exclusively brazing alloy powder is applied, a higher temperature range of the low-temperature plasma beam is chosen, preferably 570-650° C. If brazing alloy powder, flux powder, and binder powder are used as brazing material, the power of the plasma stream is adjusted in such a way that first the binder particles or the binder/flux particles and possibly the binder/flux/brazing alloy particles are fused. In this regard, the temperature should be selected in a way that avoids pyrolysis of the binder.

To increase the adhesion, the use of a transmitting (pulsed/nonpulsed) electric arc between the plasma nozzle and the surface of the aluminum component has been found to be an effective additional measure in some cases, i.e., an additional direct-current voltage source affects the power of the plasma stream.

The aluminum component is coated with the fine-grained brazing powder as described below. The brazing powder is supplied by a powder conveyor to a plasmatron that generates the low-temperature plasma beam. In the powder conveyor, the brazing powder is fluidized with gas. Suitable gases for this purpose are noble gases, hydrogen, nitrogen, carbon dioxide, and air. The use of noble gases that contain certain amounts of hydrogen, for example, argon that contains hydrogen or forming gas, has been found to be especially advantageous.

Inside the plasmatron, a primary unbalanced plasma with low electric power (<5 kW) can be generated by high-frequency alternating current (>10 kHz), for example, by a magnetron, an RF plasma, a direct high-voltage discharge, a corona barrier discharge, or similar processes. A plasma gas or working gas is introduced into the plasmatron from above through a supply line to stabilize the primary plasma. Noble gases, hydrogen, nitrogen, carbon dioxide, and air can also be used as the plasma gas or working gas. The atmospheric plasma beam that emerges from the plasmatron is distinguished by a low temperature (<1,000° C. in the core region) and low geometric expansion. The diameter of the free plasma beam is typically less than 10 mm but can be limited to values to 0.5 mm by suitable measures.

The fine-grained brazing powder can be fed to the free plasma beam in exactly metered amounts. The fine-grained brazing powder is then fused due to interaction with the plasma and accelerated towards the surface of the component to be coated, where it is finally deposited.

However, the fluidized fine-grained brazing powder can also be introduced directly into the nozzle orifice of the emerging plasma beam.

Another possibility is to convey the powder via a line directly through the primary plasma in the direction of flow of the plasma beam all the way to the nozzle orifice.

The coating method has the special advantage that the fine-grained powder can be supplied to the plasma beam with precise metering.

The brazing powder applied to the surface of the component by the plasma beam adheres well to the surface without the surface temperature of the component rising to an unacceptably high level. However, it is also possible to heat the component as well in order to support excellent adhesion of the applied coating. In the coating of extruded aluminum components, this can be realized, e.g., by utilizing the extrusion process heat.

The method can also be used for the metered application of a powdered mixture that consists of a brazing material and other powdered additives, for example, fine-grained, powdered zinc for corrosion protection or powdered functional additives to protect against wear.

The special advantage of the method of the invention is that a precisely metered, uniform and strongly adhering coating of brazing materials can be applied to the surface of an aluminum component for heat exchangers. Metered application also means limited application, so that solvents and binders can be eliminated from the manufacturing process, which helps protect the environment. Furthermore, the brazing materials can be applied to every part of the surface of the component, including, for example, the edges of a component.

Furthermore, in regard to partial coating of the component, it is possible to apply limited application widths of 0.5 mm to 10 mm locally to the component without the use of masks or screens; this is useful, for example, for applying brazing material to connecting points of pipelines or joining elements.

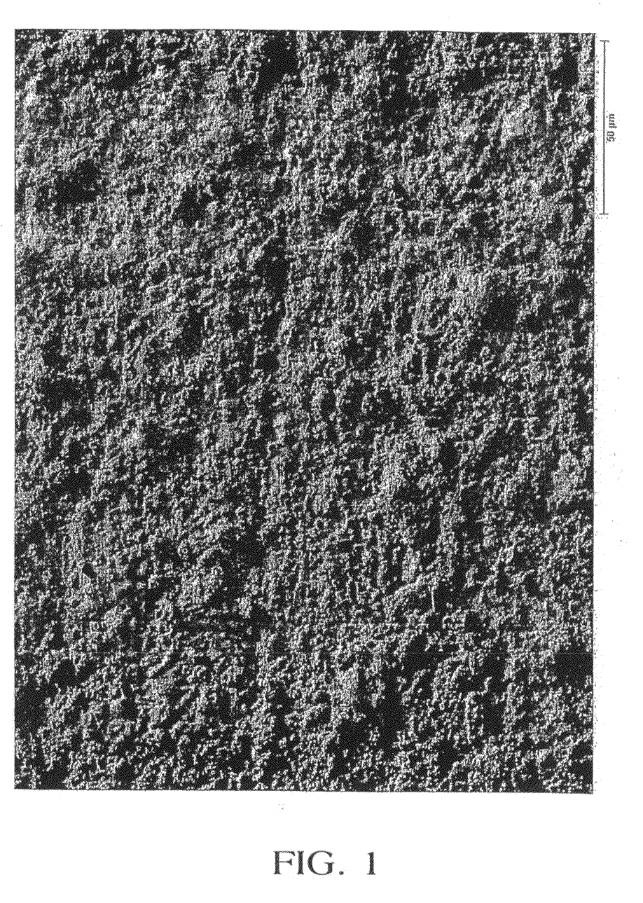

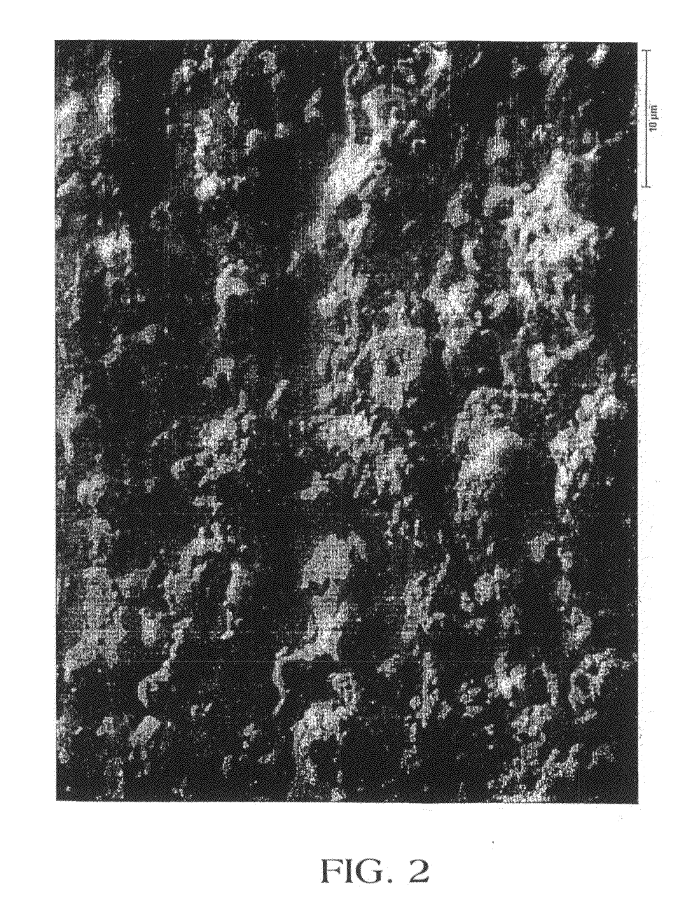

FIGS. 1 to 4 provide a comparison between an aluminum component coated in accordance with the invention (FIGS. 1 and 2) and a component coated with brazing material by roller application.

The aluminum component was plasma coated at a temperature of 595° C. Nocolok powder (potassium fluoroaluminate) was supplied to the plasmatron as the brazing material without a binder. The Nocolok powder that was used had a particle-size distribution such that 50% of all powder particles had a particle size of 2-6 μm. This powder was fluidized by means of a powder conveyor with argon to which 20 vol. % forming gas had been added. A degree of fusion of about 70% was measured by topographic measurement. FIG. 1 shows an SEM micrograph of the component coated in accordance with the invention. The coated aluminum surface is smooth to the touch and shows a uniform distribution of the particles of brazing material on the surface. Higher magnification (FIG. 2) reveals that the particles of the coating of brazing material are fused to a great extent.

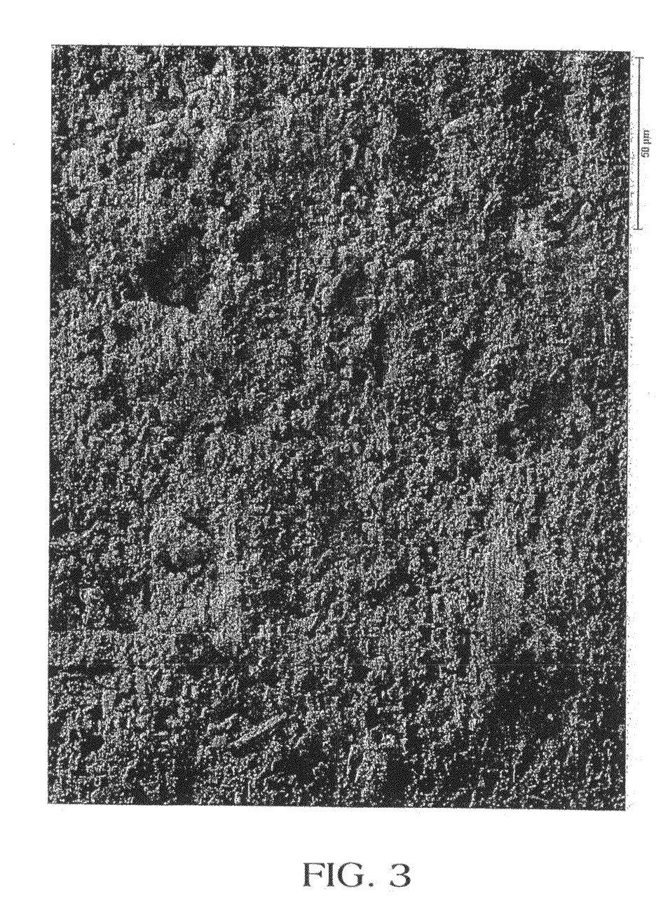

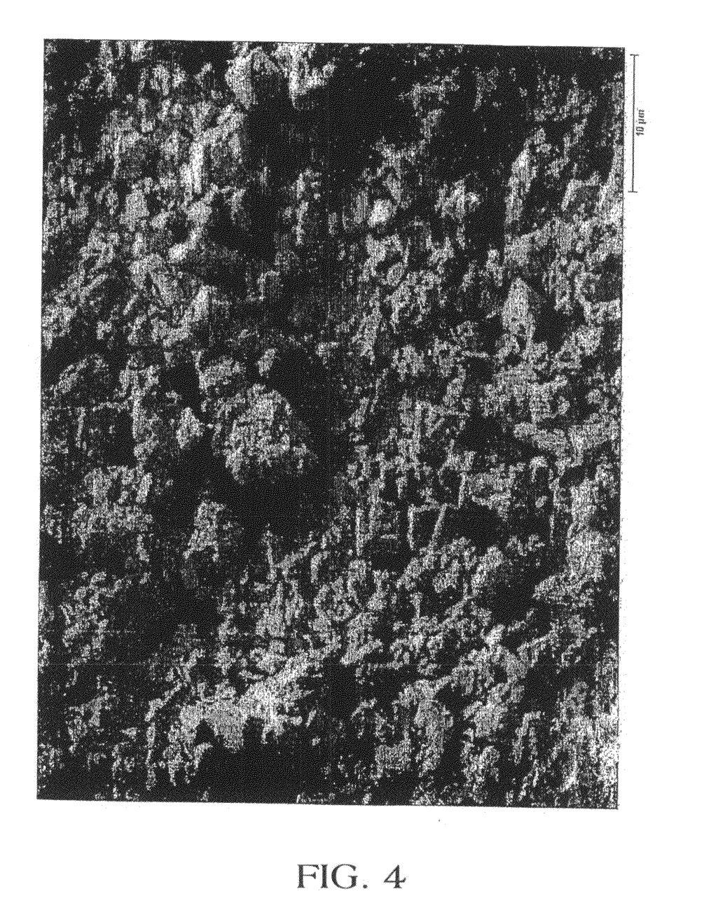

In the comparative example shown in FIGS. 3 and 4, the same Nocolok powder was dissolved together with an acrylate binder in a solvent and applied to the surface by rollers. In this case (FIG. 3), the surface does not appear quite so uniform, even though it is smooth to the touch due to the binder that is present in the coating. The crystalline particles of brazing material and their agglomerates are readily visible, especially in FIG. 4.

Both coatings show good adhesion, but only the coating of the invention shows sufficiently good coating in the edge region. Furthermore, the coating that was applied by roller produces solvent emissions, and the binder that adheres to the coated component causes pyrolysis residues in the brazing furnace. The method of the invention does not have these disadvantages.

1. A component made of aluminum material with partial or complete coating of the surfaces for brazing, which coating consists of fine-grained brazing powder with powder particle sizes of 50 nm to 100 μm, where the layer thickness of the coating is up to 100 μm, and the total amount of brazing material applied is up to 25 g/m², where the coating on the surface of the component is composed of a brazing material without binder and strongly adheres to all desired surface regions of the component, wherein the coating is very uniform; where the coating is composed of fine-grained brazing powder with a particle-size distribution in which at least 50% of the powder particles have a particle size of 1.5 to 8 μm; and where, due to the fact that the particles of brazing material are guided inside the low-temperature plasma beam directly onto the component, the particles of brazing material do not enter into undesired reactions with the ambient atmosphere.

2. A component in accordance with claim 1, wherein the fine-grained brazing material consists of a brazing alloy powder and/or flux powder.

3. A component in accordance with claim 1, wherein, when the amounts of brazing material applied are greater than 10 g/m², the fine-grained brazing material consists of a brazing alloy powder and/or flux powder with the addition of binder powder in amounts of less than 20 wt. %.

4. A component in accordance with claim 1, wherein the fine-grained brazing powder contains powdered additives, preferably zinc or powdered wear-resistant particles.

5. A method for the partial or complete coating of the surfaces of components made of aluminum material with fine-grained brazing powders with powder particle sizes of 50 nm to 100 μm, for layer thicknesses of the coating of up to 100 μm, and total amounts of brazing material to be applied of up to 25 g/m², wherein the fine-grained brazing powder with a particle-size distribution in which at least 50% of the powder particles have a particle size of 1.5 to 8 μm is supplied to a low-temperature plasma beam generated by a plasmatron; where the fine-grained brazing powder is at least partially fused in the low-temperature plasma beam at temperatures of 500° C. to 1,000° C.; and where the brazing material is sprayed onto the surfaces of the component in fused form by means of the low-temperature plasma beam, which is in direct contact with the surface of the component, and forms a uniform, strongly adhering bond with the surface of the component without the brazing material entering into undesired reactions with the ambient atmosphere.

6. A method in accordance with claim 5, wherein a degree of fusion of the fine-grained brazing powder greater than 10% and preferably 10-80% is adjusted by controlling the electric power of the low-temperature plasma beam.

7. A method in accordance with claim 5, wherein the brazing material consists of a brazing alloy powder and/or flux powder with or without binder powder.

8. A method in accordance with claim 7, wherein only selected components of the fine-grained brazing powder are fused by controlling the electric power of the low-temperature plasma beam.

9. A method in accordance with claim 5, wherein the fine-grained brazing powder, which is metered by means of a powder conveyor and fluidized by a compressed gas, is supplied to a plasmatron that generates the low-temperature plasma beam.

10. A method in accordance with claim 5, wherein a primary unbalanced plasma with low electric power (<5 kW), namely, a primary low-temperature plasma, is generated inside a plasmatron with the admission of a working gas and the production of a discharge, and the primary low-temperature plasma beam is blown out through an orifice of the plasmatron that is formed as a nozzle to the surface of the component, where the fine-grained brazing material is introduced into the primary low-temperature plasma, for example, via the plasma gas, and from there enters the secondary low-temperature plasma beam, and/or the fine-grained brazing material is introduced into a zone of the plasma nozzle that tapers towards the nozzle orifice and/or directly into the secondary low-temperature plasma beam emerging from the nozzle orifice.

11. A method in accordance with claim 10, wherein noble gases, hydrogen, nitrogen, carbon dioxide, and air are used as compressed gas and as plasma gas, preferably noble gases that contain a certain amount of hydrogen.

12. A method in accordance with claim 5, wherein limited application widths of 0.5 mm to 10 mm are locally applied to the component without the use of masks or screens.

13. A method in accordance with claim 5, wherein the component is coated immediately after it has been produced by extrusion, so that the fused particles of the brazing material impinge on a hot surface.

14. A method in accordance with claim 13, wherein the coating is carried out in-line as a process step between extrusion of the components and cooling of the coated components, before further processing by cutting, straightening, coiling of the components, or storage is undertaken.

15. A method in accordance with claim 7, wherein a noncorrosive metal fluoride powder, especially an alkali metal fluoride powder and/or an alkali metal fluoroaluminate powder, is used as flux.

16. A method in accordance with claim 7, wherein an aluminum-silicon alloy powder, preferably an alloy powder with silicon contents of 7-40 wt. %, is used as brazing alloy powder.

17. A method in accordance with claim 7, wherein a reactive alkali metal fluorosilicate or alkali metal fluorozincate is used as brazing material.

18. A method in accordance with claim 7, wherein the components are coated with a powder mixture that consists of brazing material and fine-grained, powdered zinc for corrosion protection and/or powdered functional additives to protect against wear.
